(19) United States
(12) Patent Application Publication
(10) Pub. No.: US 2005/0262904 A1
(43) Pub. Date: Dec. 1, 2005

(54) Bonding lock

(76) Inventors: Renny Tse-Haw Ling, Chung-Ho City (TW); Chun-Sheng Wu, Chung-Ho City (TW)

Correspondence Address: NORTH AMERICA INTELLECTUAL PROPERTY CORPORATION, P.O. BOX 506, MERRIFIELD, VA, 22116, US

(21) Appl. No.: 10/854,341

(22) Filed: May 27, 2004

(51) Int. Cl. E05B 67/06; E05B 73/00

(52) U.S. Cl. 70/49; 70/58

(57) ABSTRACT

A bonding lock comprises a body and a connecting member. An end of the connecting member joins to a fixed object, another end connecting to the body and constructing a loop for locking objects. The body has a slot with a slot opening, and the connecting member enters the slot via the slot opening for quickly completing buckling after a loop is formed by the connecting member and the body.

### BACKGROUND OF THE INVENTION

1. Field of the Invention

The present invention generally relates to a bonding lock for preventing theft of computer peripherals, valuable objects, bicycles, or other goods, and especially to a lock being able to fasten such objects by way of a loop.

2. Description of the Prior Art

Generally, the most common method of preventing stealing of mobile electronic products, such as portable computers, PDAs, tablet PCs, or other movable goods, is to bind aforesaid objects to a fixture such as a table leg for an example. Therefore, any of the objects will not be lost.

In U.S. Pat. No. 6,470,718, entitled “Cable Lock”, Yang discloses a joint lock. FIG. 16 shows a preferred embodiment of a circle lock that fixes an object without through holes, such as a LCD display. The cable lock mainly consists of a body and a connecting component, wherein an end of the connecting component links to the body, and another end penetrates through a through hole on the body to make a loop by restriction from the body. A length of the loop may be adjusted as needed.

Exploring the structure of U.S. Pat. No. 6,470,718, the body has a through hole allowing the connecting component to go from side to side so that a circled portion is formed by a portion of the connecting component attaching to the body.

In practice, the dimension of the circled portion may then be defined by a position of the connecting component relative to the through hole of the body. As can be seen, adjustment for the position of the connecting component relative to the through hole shall be made under a condition of the connecting component properly piercing into the through hole; hence in case of a smaller diameter of the through hole, to insert the connecting component into the through hole and adjust the circled portion may be difficult, and thus inconvenient operation obviously exists.

Besides, a curved end 20 in the body 2 is to provide a restricting function for limiting movement of the connecting component in the through hole so as to secure a constant circled portion. Due to the curved end 20 being shaped as a curve, it makes the connecting component move only in one way in the through hole while the curved end 20 pushes onto the connecting component. At the state of the curved end 20 pushing onto the connecting component, the circled portion can only be smaller gradually by the one-way movement. Furthermore, the active curved end 20 can be a weakness in preventing stealing. That is, sticking an acicular object into the connecting component (cable 3) and pushing the curved end 20 aside may thus release the connecting component.

In U.S. Pat. No. 6,401,502, which teaches locking a good without any hole for protection, since the body and the cable are connected and fastened, another good with a hole for locking is difficult to be secured. In this case the teachings in U.S. Pat. No. 5,351,507 can be utilized. As a conclusion, none of the prior arts can be applied for both situations.

### SUMMARY OF THE INVENTION

The main objective of the present invention is to quickly and easily complete fastening actions of the connecting component and the body and provide more stable buckling of the connecting component and the body.

The present invention specially designs a creative bonding lock for the fastening actions. The bonding lock features a slot for holding the connecting component instead of the through hole in prior arts. Additionally the slot has a slot opening. Hence, the connecting component crosses and enters the slot by means of the slot opening after a loop dimension is determined. The loop dimension can also be set after the connecting component is inserted into the slot opening. Thus, the connecting component is more steadily fixed in the slot.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a view of a 3-D assembling structure of a preferred embodiment of the present invention;

FIG. 2 is a view of a 3-D separating structure of a body and a connecting member of the present invention;

FIG. 3 is a 3-D view of another means of the body and the connecting member of the present invention;

FIG. 4 is a 3-D exploded view of the body of the present invention;

FIG. 5 is a sectional view of the present invention;

FIGS. 6-7 are sketches of continuous motions of a bolt being inserted into the body of the present invention;

FIG. 8 is a sectional view of the body bonding to the connecting member of the present invention;

FIG. 9 is a sectional view of the connecting member being held in the slot of another preferred embodiment of the present invention;

FIG. 10 is a sketch of the bonding lock in application of the present invention;

FIGS. 11, 12 are sketches of other preferred embodiments in application of the present invention.

### DETAILED DESCRIPTION OF THE INVENTION

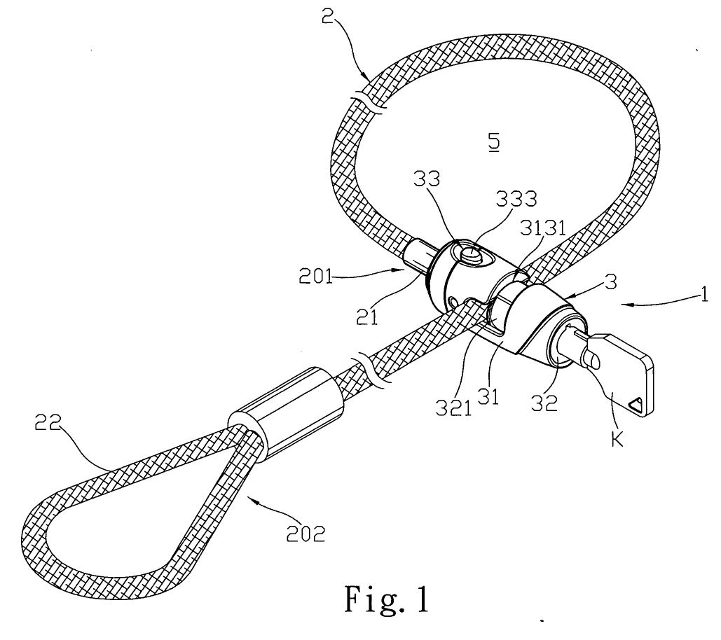

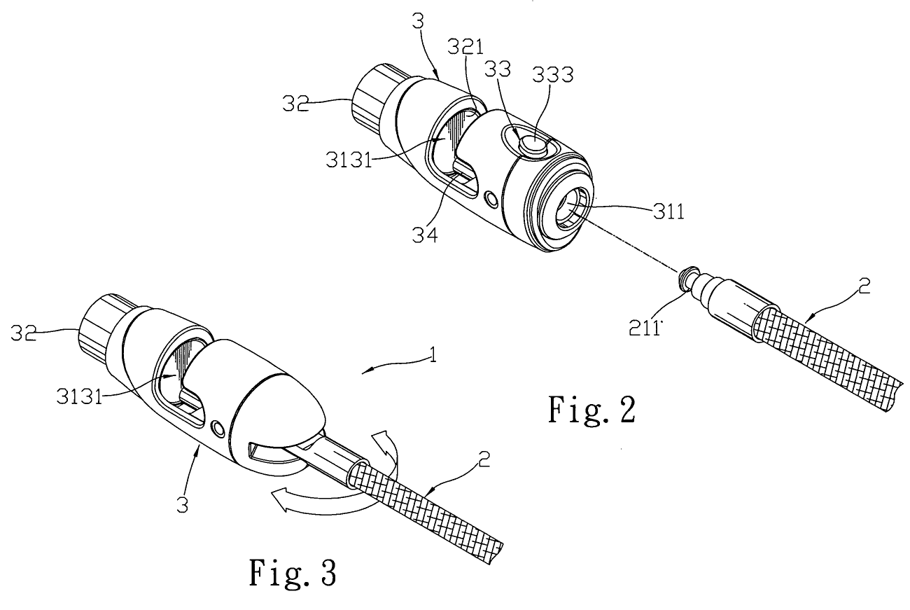

Refer to FIG. 1 and FIG. 2, which are a view of a 3-D assembling structure of a preferred embodiment of the present invention and a view of a 3-D separating structure of a body and a connecting member of the present invention. A bonding lock 1 comprises a connecting member 2 and a body 3 having a casing 31 and a locking member 32, and the connecting member 2 and the body 3 can be assembled or separated.

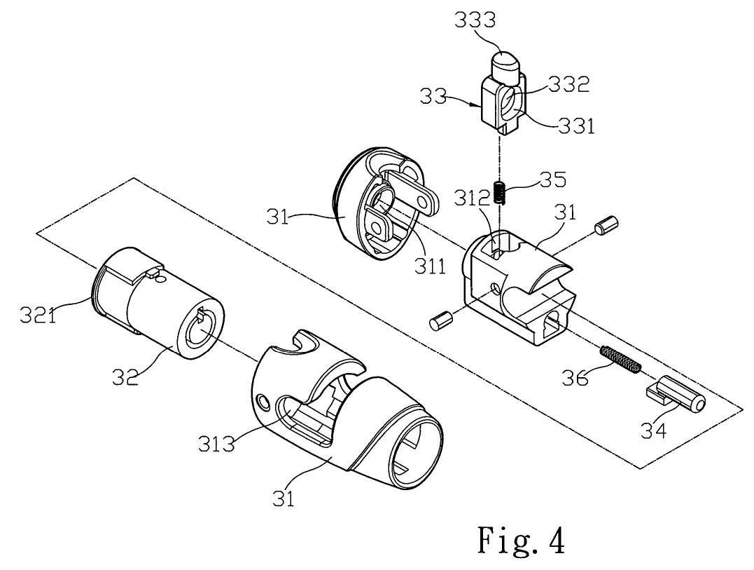

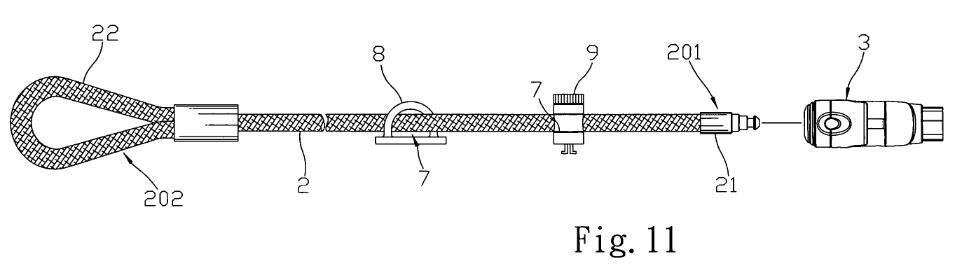

The connecting member 2 may be a rope or a strip with high hardness, and it is capable of bending while in application or binding while in storage. Besides, the connecting member 2 is possibly another structure as well, such as a chain or an interrupted rod with a plurality of sectional elements. The connecting member 2 shown in FIGS. 1 and 2 is a cable. Two ends of the connecting member 2 are defined as a connecting end 201 and a fixing end 202. The connecting end 201 connects to the body 3, and a top of the connecting end 201 is a bolt 21, which is placed into an inserting hole 311 of the body 3. Around the bolt 21 is an embedding slot 211, and the embedding slot 211 is buckled after the bolt 21 is in the inserting hole 311. Once the embedding slot 211 is fastened by the body 3 the assembly of the bolt 21 and the body 3 is completed. As mentioned, another relationship of assembly of the connecting member 2 and the body 3 can be made as well, as shown in FIG. 3. For example, the bolt 21 can connect to the body 3 pivotally. The fixing end 202 is capable of fastening with a fixed member 4 such as a table leg or a column, as shown in FIG. 10. For the fixing end 202, which can connect a fixed object 4, such as a table leg or a pillar, as shown in FIG. 10, the body 3 makes a connecting relationship with the fixed member 4 by means of the connecting member 2. A cable loop 22 of the fixing end can be looped around the fixed object 4 while in application; or the fixing end can be a structure, which directly or indirectly connects to the fixed object 4 for combination.

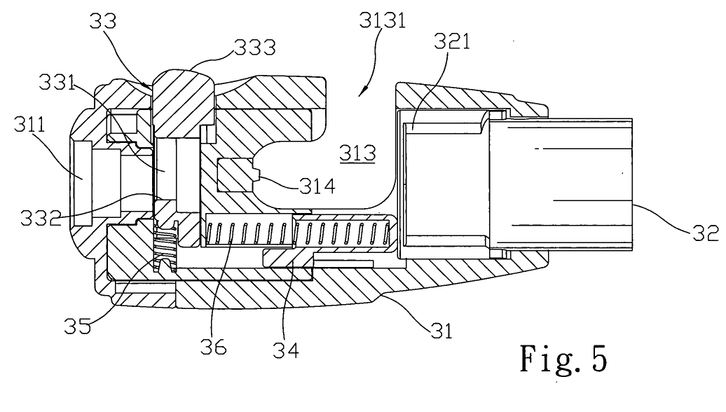

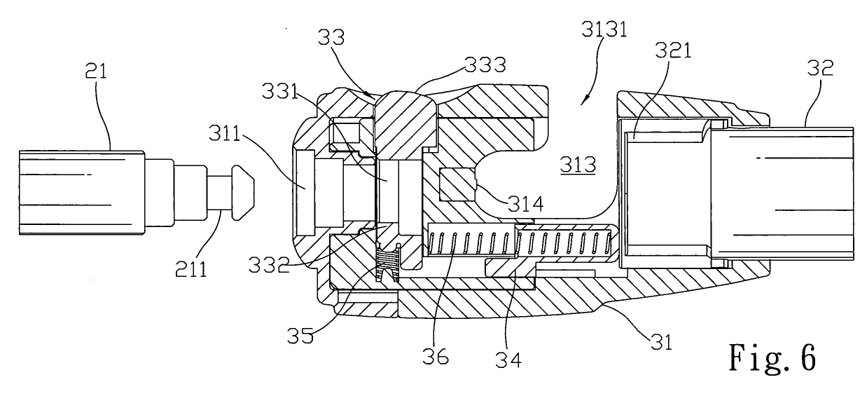

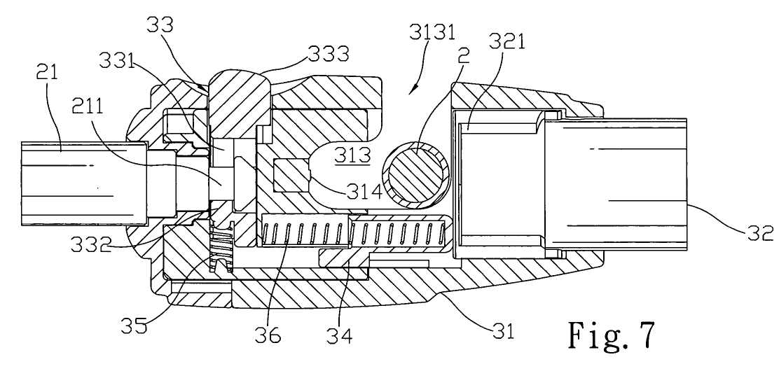

Refer to FIG. 4, which is a 3-D exploded view of the body of the present invention. The body 3 consists of the casing 31, the locking member 32 assembled on the casing 31, a movable latch 33 and a stopper 34. A room 331 connecting the inserting hole 311 is in the movable latch 33, and a shoulder 332 elongated toward the room 331 is formed on a front edge of the room 331. The movable latch 33 is in an applying slot 312 of the casing 31 and receives a first flexible member 35 in the applying slot 312 allowing the movable latch 33 to always keep in an upper dead point, shown as an upper dead end of FIG. 5. Furthermore, a top edge of the movable latch 33 slightly extends out of the body 3 to define an accepting portion 333 for receiving an external force to move. Refer to FIG. 5, which is a sectional view of the present invention. While the movable latch 33 stays in the upper dead end, the bolt 21 is blocked by the shoulder 332 and thus cannot move in and out of the inserting hole 311. Forcing the movable latch 33 to a position shown in FIG. 6, the bolt 21 is then not blocked by the shoulder 332, and can freely slide back and forth. Hence, the body 3 and the connecting member 2 can be assembled or separated from each other, as shown in FIG. 7. A slot 313 designed on the body 3 has a slot opening 3131 as an entrance for the connecting member 2 to pass through. After the connecting member 2 enters the slot 313, the locking member 32 closes the entrance of the slot opening 3131 to prevent the connecting member 2 from being removed, and therefore the body 3 and the connecting member 2 cooperate to construct a loop 5. The loop 5 is free to be adjusted by the above components.

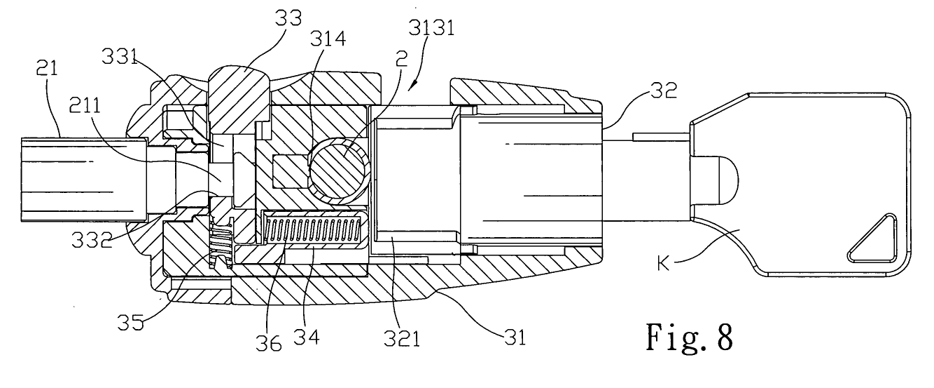

After deciding on a location of the connecting member 2, the positions of the connecting member 2 and the body 3 are fixed by means of the locking member 32 to keep a certain dimension of the loop 5. Furthermore, the locking member 32 has a closing member 321 to be moved to a stopping position by control, shown as in FIG. 8. Thus, the closing member 321 cooperates with an inner surface of the slot 313 to clamp the connecting member 2 in between, and the connecting member 2 receives radial and axial friction forces simultaneously.

In the preferred embodiment, if the locking member 32 is a key lock, a key k is able to switch either an opening state or a closing state. Of course, other examples can be adopted, such as a combination lock.

The stopper 34 is an active member combined with the body 3, and it is held by a second flexible member 36 in the body 3 to normally stay in a position that does not block the movable latch 33. While in the way of the locking member 32 driving the plug 331 to move toward the closing position, the movable latch 33 cannot then move to the bolt 21, and the bolt 21 fastened by the movable latch 33 cannot be removed.

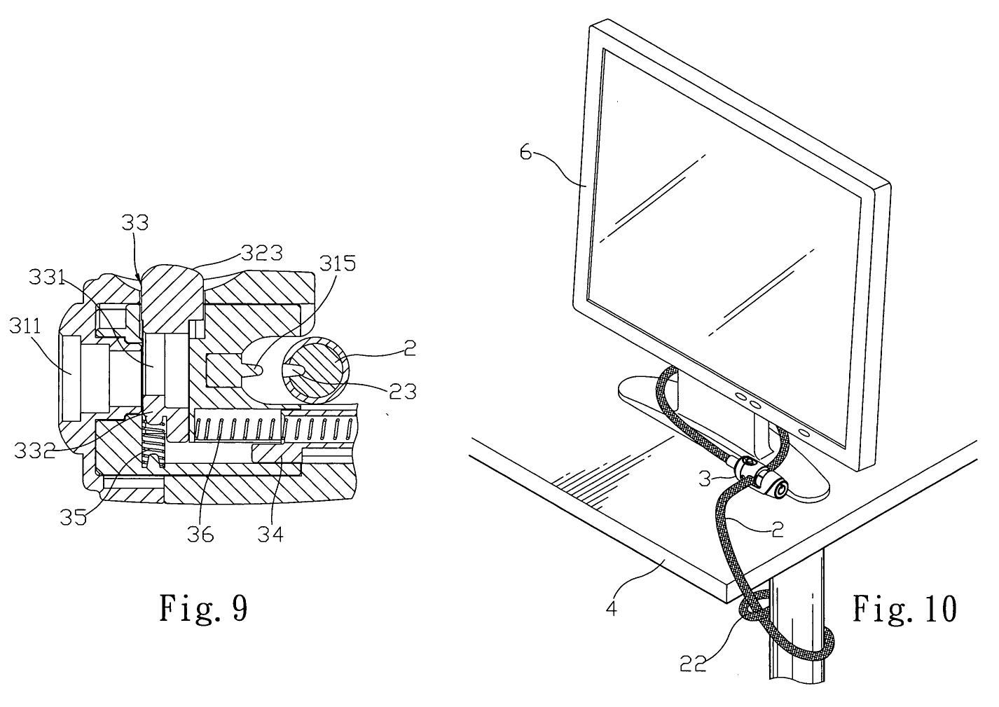

Concerning the slot 313 and the closing member 321 blocking the connecting member 2, please refer to FIG. 8. The inner surface of the slot 313 further has at least one penetrating head 314. The connecting member 2 embedded in the slot 313 cannot be moved corresponding to the slot 313 by way of friction from the penetrating head 314. Thus the loop 5 cannot be moved to change an inner diameter thereof. Refer to FIG. 9, which is a sectional view of the connecting member 2 being held in the slot 313 of another preferred embodiment of the present invention. The slot 313 and the connecting member 2 respectively have a pin 315 and an inserting slot 23. While the connecting member 2 is held in the slot 313 by the locking member 33, the pin 315 cooperates with the inserting slot 313 to prevent the diameter of the loop 5 from being changed. Besides, using a friction force between the connecting member 2 and the slot 313 as a stop is another option as well. Refer to FIG. 10, which is a sketch of the bonding lock in application according to the present invention. The connecting member 2 securely connects and fastens the fixed object 4, and the connecting member 2 completely connects to the body 3, and thus the connecting member 2 and the body 3 cooperate to construct the loop 5 to bundle a neck portion of a locked object 6. Further, the loop 5 is adjustable to be suitable to variable locked objects.

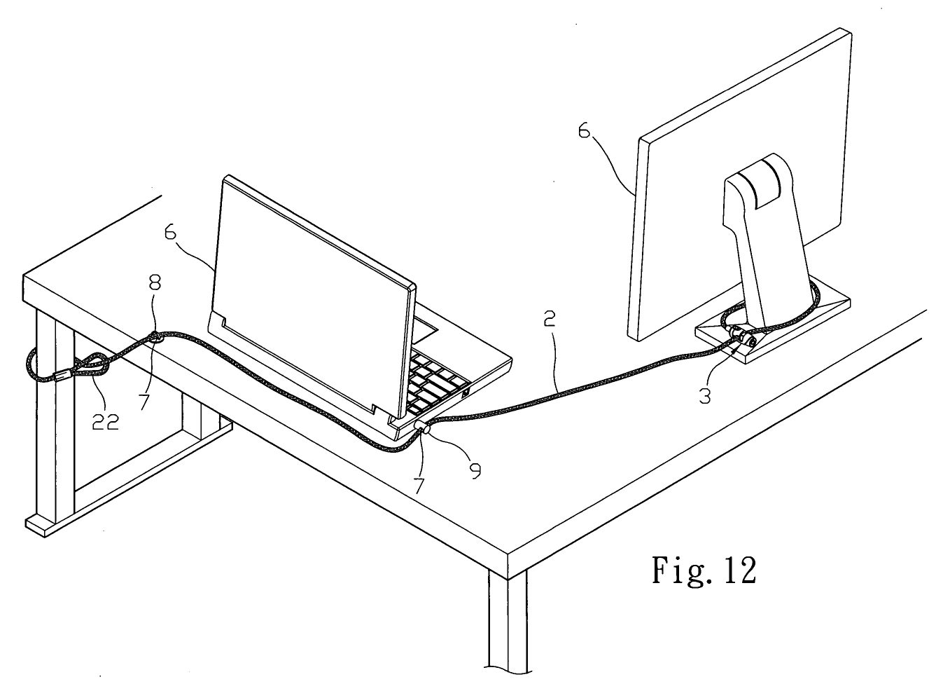

Refer to FIGS. 11, 12, which are sketches of other preferred embodiments in application of the present invention. The connecting member 2 can be put through a locked object 6 with a hole 7 in advance, or combined with a fixed object 8 or a locking head 9 on the locked object 6. Then the connecting member 2 is just assembled with the body; thus, all the objects connected to the connecting member 2 are protected.

As a conclusion, the bonding lock 1 is capable of offering the locking protection of the loop 5, simultaneously to protect locked objects 8, 9 featuring the hole 7.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

1. A bonding lock comprising a body and a connecting member, a fixing end of the connecting member joining a fixed object, a connecting end connecting to the body and constructing a loop, wherein the body comprises:
a bolt formed on the connecting end and placed into an inserting hole of the body:
a casing having a slot thereon, the slot having a slot opening for the connecting member to enter; and
a locking member in the casing having a closing member, the closing member being moved to close an entrance of the slot opening and cooperate with an inner surface of the slot to clamp the connecting member for preventing the connecting member from being removed, the connecting member receiving radial and axial friction forces simultaneously.

2. The bonding lock as cited in claim 1, wherein a surface of the slot has at least one penetrating head for going through the connecting member.

3. The bonding lock as cited in claim 1, wherein the closing member has at least one pin for going through the connecting member.

4. The bonding lock as cited in claim 1, wherein a an embedding slot is formed on the bolt.

5. The bonding lock as cited in claim 4, wherein the embedding slot is installed on the inserting hole.

6. The bonding lock as cited in claim 1, wherein the bolt connects to the body pivotally.

7. The bonding lock as cited in claim 1, wherein the body further:
a movable latch having a first position for blocking the bolt and a second position for removing the bolt from the inserting hole.

8. The bonding lock as cited in claim 7, wherein the casing further has a first flexible member to move the movable latch back to the second position.

9. The bonding lock as cited in claim 7, wherein the body further comprises a stopper to limit the movable latch in the first position.

10. The bonding lock as cited in claim 9, wherein the body further comprises a second flexible member therein to hold the stopper so as to keep the stopper at a position that does no limit movement of the movable latch.

11. The bonding lock as cited in claim 7, wherein the body further comprises a room connecting to the inserting hole for receiving the bolt, the room comprising
a shoulder set to buckle the connecting end.
